(19) United States
(12) Patent Application Publication
(10) Pub. No.: US 2026/0158776 A1
(43) Pub. Date: Jun. 11, 2026

(54) METHOD FOR CORRECTING THE THICKNESS OF A LAYER

(71) Applicant: COMMISSARIAT A L'ENERGIE ATOMIQUE ET AUX ENERGIES ALTERNATIVES, Paris (FR)

(72) Inventors: Marie Bousquet, Grenoble (FR); Alexandre Reinhardt, Grenoble (FR); Aude Lefevre, Grenoble (FR); Pierre Perreau, Grenoble (FR)

(73) Assignee: COMMISSARIAT A L'ENERGIE ATOMIQUE ET AUX ENERGIES ALTERNATIVES, Paris (FR)

(21) Appl. No.: 19/410,365

(22) Filed: Dec. 5, 2025

(30) Foreign Application Priority Data
Dec. 6, 2024 (FR) 24/13534

(51) Int. Cl. B32B 38/18; B32B 3/26; B32B 15/00; B32B 38/00

(52) U.S. Cl. CPC B32B 38/1866; B32B 3/263; B32B 15/00; B32B 38/0036; B32B 2038/0048; B32B 2038/0064; B32B 2250/02; B32B 2307/20; B32B 2307/7376; B32B 2309/105

(57) ABSTRACT

A method for correcting thickness including successively a step of providing a carrier substrate including a thin layer, the thin layer having a surface extending up to a peripheral edge; an etching step, in which the thin layer is selectively etched by localized ion bombing, so that a thickness of the thin layer varies progressively from a center of the thin layer towards the peripheral edge; and a planarization step, in which the thin layer is polished by chemical-mechanical polishing, so that, upon completion of the planarization step, the thin layer has a substantially planar surface up to the peripheral edge.

### TECHNICAL FIELD OF THE INVENTION

The present invention relates to the field of microelectronics, and more particularly to methods for correcting the thickness of thin layers.

### PRIOR ART

In the field of microelectronics, the performances of manufactured micrometric devices may depend on some geometric parameters of constituent elements of these devices. For example, in the case of acoustic resonators or filters, the performances depend on the thicknesses of the layers that are used, in particular of the piezoelectric material layer. Indeed, its thickness or the variations in the thickness of the layer affects the resonance frequency (fᵣ), the coupling coefficient (k²), the bandwidth, or its quality factor (Q).

Consequently, it is crucial to be able to master the thickness (in terms of target value and homogeneity) of the piezoelectric material layer, at the level of the substrate on which it is deposited. This is made particularly difficult because such a layer has a small thickness.

More generally, it is frequently desired to monitor the thickness of a layer, and guarantee its target value.

In order to meet these objectives, it is known from the prior art to correct the thickness of a thin layer by using a localized etching method (or trimming in English) implemented after a measuring step. For example, the implementation of a localized etching by ion bombing allows locally correcting a thickness defect to homogenize a layer and to reach its target value. Although such a method is satisfactory in that it allows making a layer more uniform and closer to the target value, in the case of piezoelectric materials, it causes the formation of an amorphous material layer at the surface of the layer which should be subsequently removed. This amorphous material layer could degrade the performances of the manufactured micrometric devices.

To remove this amorphous material layer, it is known to implement, either a heat treatment at a temperature comprised between 200° C. and 500° C., or to carry out a chemical-mechanical polishing (or Chemical Mechanical Polishing—CMP, in English) over the surface, or a combination of both.

Although these solutions are satisfactory in that they allow removing the amorphous material layer, they have some drawbacks. The implementation of a heat treatment could cause the loss of some light elements in the material, like for example Lithium (Li), potassium (K) or sodium (Na) which are sometimes included in piezoelectric materials. In turn, the chemical-mechanical polishing sometimes results in an unevenness over the planarized surface.

Hence, there is a need to find a method for correcting thicknesses, allowing making a layer homogeneous enough, at the substrate scale, without causing the formation of an amorphous material layer at the surface.

### Object of the Invention

The present invention aims to provide a solution that addresses all or part of the aforementioned problems.

This aim could be achieved thanks to the implementation of a method for correcting thicknesses, the method comprising successively:
a step of providing a carrier substrate comprising a thin layer, said thin layer having a surface extending up to a peripheral edge;
an etching step, in which the thin layer is selectively etched by localized ion bombing, so that a thickness of said thin layer varies progressively from a center of the thin layer towards the peripheral edge; and
a planarization step, in which the thin layer is thinned by chemical-mechanical polishing, so that, upon completion of the planarization step, the thin layer has a substantially planar surface extending up to the peripheral edge.

The previously-described arrangements allow providing a method for correcting thicknesses that takes advantage of the localized etching during the etching step to create a specific topography of the thin layer. Thus, the etching step allows preparing the surface of the thin layer to improve the thickness homogeneity obtained during the planarization step. In a synergistic manner, the planarization step also allows removing any amorphous layer accidentally deposited during the etching step.

The method for correcting thicknesses may further have one or more of the following features, considered separately or in combination.

According to one embodiment, the etching step is implemented by ion species bombing, for example with argon (Ar), nitrogen trifluoride (NHF₃/NF₃), or trifluoromethane (CHF₄), over the surface of the thin layer. For example, the ion species bombing is carried out at an energy comprised between 0.05 and 3.0 MeV, with an ion dose comprised between 10¹⁰ and 10¹⁶ at/cm².

By “substantially homogeneous” thickness, it should be understood that, upon completion of the planarization step, the surface of the thin layer presents thickness variations lower than 1% and/or a percentage of unevenness lower than 1%.

For example, it is possible to characterize the surface thickness homogeneity in %, as being, for a set of points distributed over said surface, a ratio of the standard deviation to the mean of the thickness of the thin layer at each of these points, multiplied by 100:

$$\% StdD = 100 * \frac{StdD}{Mean} ,$$

For example, it is possible to characterize the percentage of unevenness as being, for a set of points distributed over said surface, a ratio of the extent to twice the mean of the thickness of the thin layer at each of these points, multiplied by 100:

$$\% Non U = 100 * \frac{Range}{2 * Mean} .$$

According to one embodiment, during the provision step, the thin layer has a thickness smaller than 2 μm, and in particular smaller than 1 μm.

Thus, the method for correcting thicknesses is suitable for correcting the thickness of layers used for making microelectronic devices.

According to one embodiment, the etching step is implemented so that, upon completion of the etching step, the thickness profile of the etched thin layer has a concave shape.

The term “concave” related to the thickness profile of the etched thin layer means that the thickness of the thin layer decreases from the center of the carrier substrate up to the peripheral edge.

Thus, the etched thin layer is prepared so that, during the planarization step, the etched thin layer is polished starting with the center. Such a preparation of the thin layer allows obtaining a greater thickness homogeneity after polishing than is the case when the thin layer is not selectively etched.

According to one embodiment, the etching step is implemented so that, upon completion of the etching step, the thickness profile of the etched thin layer has a convex shape.

The term “convex” related to the surface of the etched thin layer means that the thickness of the thin layer increases from the center of the carrier substrate up to the peripheral edge.

Thus, the etched thin layer is prepared so that, during the planarization step, the etched thin layer is polished starting with the peripheral edge. Such a preparation of the thin layer allows obtaining a greater thickness homogeneity after polishing than is the case when the thin layer is not selectively etched.

According to one embodiment, during the etching step, the thin layer is etched only on the surface of the thin layer, so that the thickness of said thin layer gradually varies from the center of the thin layer toward the peripheral edge, according to a thickness profile having a concave or convex shape, preferably when the secondary face is substantially flat.

According to one embodiment, the secondary face is substantially flat.

“Substantially flat” means that the secondary face has a curvature that is strictly less than a curvature of the surface of the thin layer after the etching step. For example, the secondary face has a radius of curvature that is strictly greater than a radius of curvature of the surface of the thin layer after the etching step.

According to one embodiment, the method for correcting thicknesses comprises a test sub-step, implemented before the etching step, in which a test substrate comprising a test thin layer is provided, the test thin layer being made of a material identical to a material of the thin layer, the test sub-step comprising:
thinning the test thin layer by chemical-mechanical polishing; then
measuring at different locations a thickness of the test thin layer, by ellipsometry or reflectometry, so as to determine, for each of said locations, a variation in the thickness of the test thin layer;
the etching step being implemented afterwards while taking account of said test sub-step.

Thus, it is possible to adapt the etching step according to the material used for the thin layer.

According to one embodiment, the planarization step is implemented in the same manner as the thinning implemented during the test sub-step.

In other words, the polishing parameters and solutions used during the test sub-step could be used during the planarization step and vice versa.

Thus, the test sub-step allows anticipating the result of the planarization step, on a test thin layer. Thus, it is possible to use the results of the test sub-step for a large amount of thin layers.

According to one embodiment, the method for correcting thicknesses further comprises a heat treatment step, implemented after the etching step, in which the thin layer undergoes a heat treatment at an annealing temperature comprised between 200° C. and 500° C.

Thus, it is possible to remove at least partially an amorphous material layer formed at the surface of the thin layer during the etching step.

According to one embodiment, the thin layer is a layer of a pyroelectric, ferroelectric or piezoelectric material.

Thus, the method for correcting thicknesses is suitable for the manufacture of microelectronic devices or of optical or acoustic microsystems.

In particular, the method for correcting thicknesses is suitable for the manufacture of acoustic resonators or filters, like surface acoustic wave resonators (SAW for Surface Acoustic Wave), bulk wave resonators (BAW for Bulk Acoustic Wave), or Lamb wave resonators.

For example, said piezoelectric material may be selected from the group comprising: LiNbO₃, LiTaO₃, LiNb₁₋ₓTaₓO₃, quartz (SiO₂), PbZr₁₋ₓTiₓO₃, KNbO₃, KTaO₃, NaNbO₃, KNb₁₋ₓTaₓO₃, KTa₁₋ₓNbₓO₃, BaTiO₃, SrTiO₃, Ba₁₋ₓSrₓTiO₃, where 0≤x≤1.

According to one embodiment, the thin layer is a monocrystalline layer.

According to one embodiment, the thin layer comprises LiNbO₃ or LiTaO₃.

Thus, the manufacturing method is particularly suitable for the manufacture of acoustic resonators.

According to one embodiment, the method for correcting thicknesses further comprises a measuring step, implemented before the etching step, in which a measurement at different locations of a thickness of the thin layer is carried out by ellipsometry or reflectometry.

Thus, it is possible to adapt the etching step according to the result of the measuring step. This allows forming the etched surface, while limiting to a minimum the material shrinkage during the etching step.

According to one embodiment, the measuring step is carried out by ellipsometry, in particular in the case where an average thickness of the thin layer is smaller than or equal to 1 μm.

According to one embodiment, the measuring step is carried out by reflectometry, in particular in the case where an average thickness of the thin layer is strictly larger than 1 μm.

For example, the measuring step may be implemented so as to measure a thickness of the thin layer at 9 to 121 distinct points selected over the surface of the thin layer.

According to one embodiment, the provision step comprises the following steps:
a step of providing a donor substrate comprising a thick layer, the donor substrate having a bonding surface on the side of the thick layer;
an implantation step, in which light species are implanted in the thick layer to generate an embrittlement plane therein and thus define the thin layer between the embrittlement plane and the bonding surface of the donor substrate;
an assembly step, in which the bonding surface of the donor substrate is brought into contact with a receiving face of the carrier substrate;
a detachment step, in which the thin layer is formed by detachment of a portion of the thick layer at the embrittlement plane, by application of a heat treatment.

The previously-described steps allow sampling a thin layer of a solid substrate by fracture, by using the Smart Cut™ technology.

According to one embodiment, during the etching step, a variation in the thickness of the thin layer between the center of the thin layer and the peripheral edge is comprised between 50 nm and 200 nm.

The previously-described thickness ranges allow obtaining a proper preparation of the surface before the implementation of a planarization step, while limiting thinning of the thin layer during the method for correcting thicknesses. Thus, it is possible to keep a substantial control over the thickness of the thin layer, which is a particularly critical parameter in the manufacture of micrometric acoustic resonators.

### BRIEF DESCRIPTION OF THE DRAWINGS

Other aspects, aims, advantages and features of the invention will appear better upon reading the following detailed description of preferred embodiments of the latter, given as a non-limiting example, and made with reference to the appended drawings wherein:

FIG. 1 is a schematic view of a provision step according to an embodiment of the invention.

FIG. 2 is a schematic view of a provision step according to another embodiment of the invention, using the SmartCut™ technology.

FIGS. 3A-3C are a schematic view of a measuring step according to an embodiment of the invention.

FIGS. 4A and 4B are a schematic view of the result of a test sub-step according to an embodiment of the invention.

FIG. 5 is a schematic view of the last steps of the method for correcting thicknesses according to a first embodiment of the invention.

FIG. 6 is a schematic view of the last steps of the method for correcting thicknesses according to a second embodiment of the invention.

### DETAILED DESCRIPTION

In the figures and in the following description, the same references represent identical or similar elements. In addition, the different elements are not plotted to scale so as to favor clarity of the figures. Moreover, the different embodiments and variants do not exclude each other and could be combined together.

As illustrated in FIGS. 1 to 6, the invention relates to a method for correcting thickness of a layer 2. By “correcting thickness”, it should be understood a method consisting in making the thickness of layer 2 substantially equal to a target value across the entire surface of substrate 1. Reaching a target thickness value is a determining parameter for many applications in the fields of microelectronics. Hence, the method may be adapted to different devices for which a precise thickness is required.

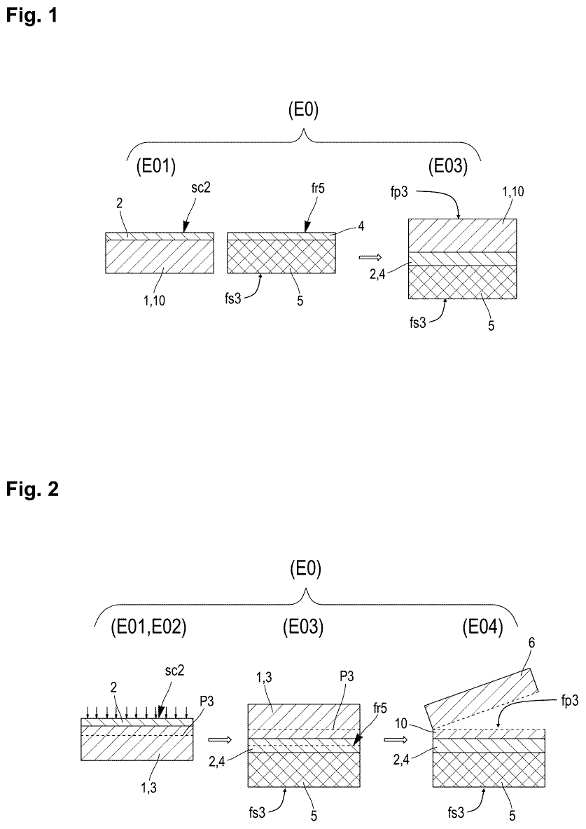

The method primarily comprises a step of providing E0 a carrier substrate 5 comprising a main face fp3, and a secondary face fs3 opposite to the main face fp3. The carrier substrate 5 further comprises a thin layer 10 arranged on the side of the main face fp3. This thin layer 10 has a surface s10 extending up to a peripheral edge b10. In general, the thin layer 10 has a thickness e10 smaller than 2 μm, and in particular smaller than 1 μm. FIGS. 1 and 2 show two different implementations of the provision step E0.

As shown in FIG. 1, a provision step E01 may be implemented, in which a donor substrate 1 comprising a thin layer 10 is provided. The donor substrate 1 may also comprise a primary bonding layer 2 disposed over the thin layer 10, which has a bonding surface sc2 opposite to the thin layer 10. This donor substrate 1 may be flipped over and affixed on a secondary bonding layer 4 disposed over the carrier substrate 5, during an assembly step E03. In other words, during this assembly step E03, the bonding surface sc2 of the primary bonding layer 2 is brought into contact with a receiving face fr5 of the carrier substrate 5, said receiving face fr5 being formed over the secondary bonding layer 4. The resulting stack then comprises the superposition, in that order, of the carrier substrate 5, of the primary and secondary bonding layers 2, 4, and of the thin layer 10 whose thickness needs to be corrected. In this case, the carrier substrate 5 comprises the secondary face fs3 opposite to the primary and secondary bonding layers 2, 4. The thin layer 10 forms the main face fp3, opposite to the primary and secondary bonding layers 2, 4.

FIG. 2 illustrates another implementation of the provision step E0, known as SmartCut™. In brief, this embodiment may comprise the following steps.

Like before, a provision step E01 is implemented, in which a donor substrate 1 is provided. This donor substrate 1 comprises a thick layer 3, and optionally a primary bonding layer 2 disposed over the thick layer 3. Thus, the donor substrate 1 has a bonding surface sc2 on the side of the thick layer 3, and in particular on the side of the primary bonding layer 2.

Afterwards, an implantation step E02 may be implemented, in which light chemical species are implanted in the thick layer 3 to generate an embrittlement plane P3 therein. This embrittlement plane P3 will subsequently delimit the thin layer 10 with the main face fp3.

Afterwards, the assembly step E03 is implemented by bringing the bonding surface sc2 of the donor substrate 1 into contact with a receiving face fr5 of the carrier substrate 5. Like before, it may be advantageous that the receiving face fr5 of the carrier substrate is formed over a secondary bonding layer 4. Thus, a bonding is carried out between the bonding surface sc2 and the receiving face fr5 via primary and secondary bonding layers 2, 4.

Finally, a detachment step E04 may be implemented. During this step, the thin layer 10 is formed by detachment of a portion 6 of the thick layer 3 at the embrittlement plane P3, by application of a heat treatment. Hence, it should be understood that the thin layer 10 is the portion of the thick layer 3 that remains after detachment of the portion 6 of the thick layer. Thus, the main face fc3 is formed by the thin layer 10, at the embrittlement plane P3. The carrier substrate 5 may comprise the secondary face fs3 opposite to the primary and secondary bonding layers 2, 4. The previously-described steps allow sampling a thin layer 10 of a solid substrate by fracture, by using the Smart Cut™ technology.

Such a technology is frequently implemented for forming thin layers of some materials like pyroelectric, ferroelectric or piezoelectric material. Incidentally, the thin layer 10 whose thickness needs to be corrected according to the invention could be a layer of one of these material types. The thin layer 10 could be a monocrystalline layer. Thus, the method for correcting thicknesses is suitable for the manufacture of optical or acoustic microelectronic devices. In particular, the method for correcting thicknesses is suitable for the manufacture of acoustic resonators or filters, like surface acoustic wave resonators (or SAW, standing for Surface Acoustic Wave according to the relevant Anglo-Saxon terminology), bulk wave resonators (or BAW, standing for Bulk Acoustic Wave according to the relevant Anglo-Saxon terminology), or Lamb wave resonators.

For example, said piezoelectric material may be selected in the group comprising: LiNbO₃, LiTaO₃, LiNb₁₋ₓTaₓO₃, quartz (SiO₂), PbZr₁₋ₓTiₓO₃, KNbO₃, KTaO₃, NaNbO₃, KNb₁₋ₓTaₓO₃, KTa₁₋ₓNbₓO₃, BaTiO₃, SrTiO₃, Ba₁₋ₓSrₓTiO₃, where 0<x<1. More specifically, the thin layer 10 may comprise or be made of LiNbO₃, or LiTaO₃. Thus, the manufacturing method is particularly suitable for the manufacture of acoustic resonators.

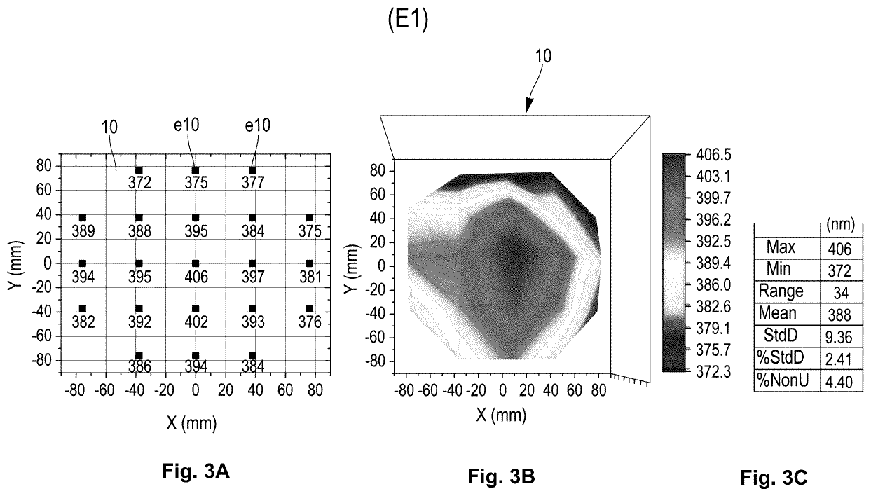

Referring to FIG. 3, the method for correcting thicknesses may advantageously comprise a measuring step E1, in which a measurement of the thickness at different locations of the surface s10 of the thin layer 10 is carried out by ellipsometry or reflectometry. Thus, it is possible to adapt an etching step E2 (which will be described later on), according to the result of the measuring step E1. This allows forming the etched surface s10, while limiting to a minimum the material shrinkage during the etching step E2.

More specifically, the measuring step E1 may be carried out by ellipsometry, in particular in the case where an average thickness e10 of the thin layer 10 is smaller than or equal to 1 μm, and by reflectometry, in particular in the case where an average thickness e10 of the thin layer 10 is strictly larger than 1 μm.

For example, the measuring step E1 may be implemented so as to measure a thickness e10 of the thin layer 10 at 9 to 121 distinct points selected over the surface s10 of the thin layer 10. FIG. 3 illustrates a variant wherein the measuring step E1 is carried out by measuring the thickness of the thin layer 10 at 21 points distributed over the surface s10 in the plane formed by the X and Y axes of an area of the surface s10 (cf. the graph denoted A). Thus, it is possible to obtain a distribution of the thickness e10 of the thin layer 10 over the surface s10 (cf. the graph denoted B).

Advantageously, this measuring step E1 allows characterizing the surface evenness % StdD and/or the percentage of unevenness % NonU. The table denoted C presents the values obtained for this measuring step. The surface evenness, denoted “% StdD” in %, is calculated so as to be, for all of the 21 points distributed over the surface s10, a ratio of the standard deviation denoted “StdD” to the mean denoted “Mean” of the thickness e10 of the thin layer 10 at each of these points, multiplied by 100:

$$\% StdD = 100 * \frac{StdD}{Mean} .$$

The percentage of unevenness, denoted “% NonU”, may be defined as being, for all of the 21 points distributed over the surface s10, a ratio of the extent denoted “Range” to twice the mean Mean of the thickness e10 of the thin layer 10 at each of these points, multiplied by 100:

$$\% Non U = 100 * \frac{Range}{2 * Mean} .$$

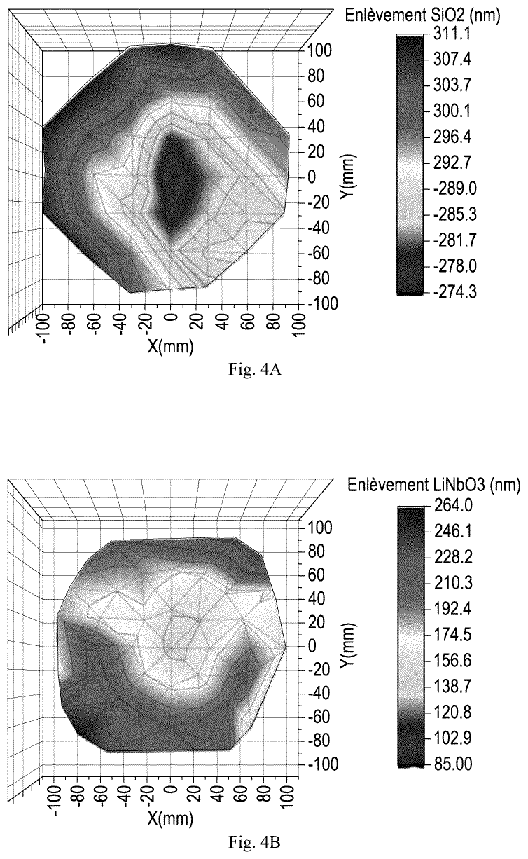

As illustrated in FIG. 4, the method for correcting thicknesses may advantageously comprise a test sub-step E12, implemented before an etching step E2 which will be described later on. During this test sub-step E12, a test substrate 20 comprising a test thin layer 21 is provided. The test thin layer 21 is made of a material identical to a material of the thin layer 10. For example, as illustrated in FIG. 4, Part A, the test thin layer 21 is made of a silicon oxide SiO₂. Alternatively, and as illustrated in FIG. 4, Part B, the test thin layer 21 is made of lithium niobate LiNbO₃. The test sub-step E12 may then comprise successively:
thinning the test thin layer 21 by chemical-mechanical polishing; then
measuring, at different locations, a thickness of the test thin layer 21, by ellipsometry or reflectometry, so as to determine, for each of said locations, a variation in the thickness of the test thin layer 21.

Thus, it is possible to determine, according to the constituent material of the thin layer 10 and of the test thin layer 12, which thickness variation will be obtained at different points of the thin layer 10. As shown in FIG. 4, thinning the test thin layer 21 for both material types (Part A and Part B) results in a thickness variation that is more significant at the periphery of the thin layer than towards the center. Incidentally, one could notice that the thickness variation is more pronounced for a test thin layer 21 made of lithium niobate LiNbO₃ than for a test thin layer 21 made of silicon oxide SiO₂. Thus, the test sub-step E12 allows anticipating the result of the planarization step E3 (described hereafter) on a test thin layer 21. Thus, it is possible to use the result of the test sub-step E12 for a large amount of thin layers 10.

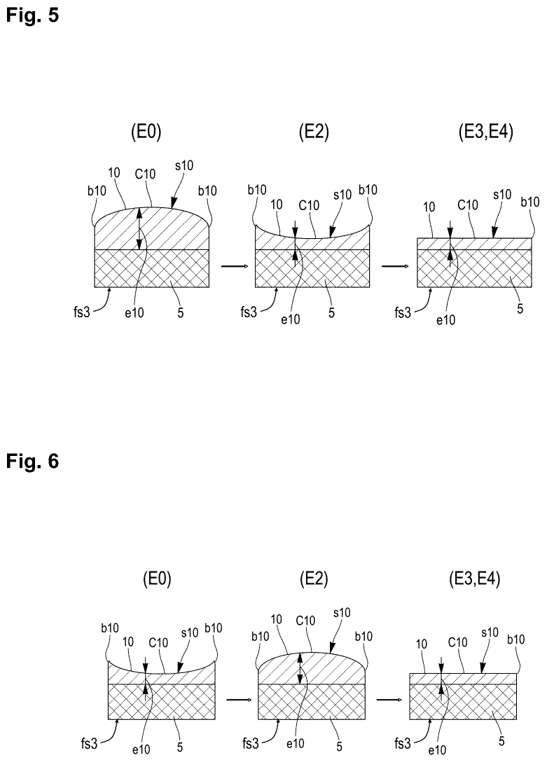

Next, FIGS. 5 and 6 illustrate the remaining steps of the method for correcting thicknesses, and in particular the etching step E2, in which the thin layer 10 is selectively etched by localized ion bombing and only on the side of the surface (s10) of the thin layer (10), so that a thickness e10 of said thin layer 10 varies progressively from a center C10 of the thin layer 10 towards the peripheral edge b10. For example, the etching step E2 is implemented by bombing ion species onto the surface s10 of the thin layer 10. For example, the ion species bombing comprises bombing argon (Ar), nitrogen trifluoride (NHF₃/NF₃), or trifluoromethane (CHF₄) at an energy comprised between 0.05 and 3.0 MeV, with an ion dose comprised between 10¹⁰ and 10¹⁶ at/cm².

In general, during the etching step E2, a variation in the thickness e10 of the thin layer 10 between the center C10 of the thin layer 10 and the peripheral edge b10 is comprised between 50 nm and 200 nm. The previously-described thickness e10 ranges allow obtaining a proper preparation of the surface s10 before the implementation of a planarization step E3 (which will be described later on), while limiting thinning of the thin layer 10 during the method for correcting thicknesses. Thus, it is possible to keep a substantial control over the thickness e10 of the thin layer 10, which is a particularly critical parameter in the manufacture of micrometric acoustic resonators.

FIG. 5 illustrates a first variant wherein the etching step E2 is implemented so that, upon completion of the etching step E2, the thickness profile of the etched thin layer 10 has a concave shape. The term “concave”, when related to the thickness profile of the etched thin layer 10 means that the thickness e10 of the thin layer 10 increases from the center C10 of the carrier substrate 5 up to the peripheral edge b10. Thus, the etched thin layer 10 is prepared so that, during the planarization step E3, the etched thin layer 10 is polished starting with the peripheral edge b10. Such a preparation of the thin layer 10 allows obtaining a greater thickness evenness after polishing than is the case when the thin layer 10 is not locally etched before.

Alternatively, and as shown in FIG. 6, the etching step E2 is implemented so that, upon completion of the etching step E2, the thickness profile of the etched thin layer 10 has a convex shape. The term “convex”, when related to the thickness profile of the etched thin layer 10 means that the thickness e10 of the thin layer 10 decreases from the center C10 of the carrier substrate 5 up to the peripheral edge b10. Thus, the etched thin layer 10 is prepared so that during the planarization step E3, the etched thin layer 10 is polished starting with the center C10. Such a preparation of the thin layer 10 allows obtaining a more significant surface evenness after polishing than is the case when the thin layer 10 is not selectively etched.

Irrespective of the variant that is used, if a test sub-step E12 is implemented, the etching step 2 could be implemented while taking account of said test sub-step 12. For example, it is possible to generate a concave curvature or a convex curvature which depends on the thickness variation measured during the test sub-step E12. Thus, a greater concave curvature or convex curvature may be implemented if ever a significant variation in the thickness of the test thin layer 21 is measured. For example, a concave curvature or a convex curvature may be proportional to a significant variation in the thickness of the test thin layer 21 measured during the test sub-step E12. Thus, it is possible to adapt the etching step E2 according to the material used for the thin layer 10.

Generally, during the etching step E2, the thin layer 10 is etched only on the surface s10 of thin layer 10, so that secondary face fs3 remains substantially flat. “Substantially flat” means that the secondary face fs3 has a curvature that is strictly less than a curvature of the surface s10 of the thin layer 10. For example, the secondary face fs3 has a radius of curvature that is strictly greater than a radius of curvature of the surface s10 of the thin layer 10.

Afterwards, the method for correcting thicknesses comprises a planarization step E3, in which the thin layer 10 is thinned by chemical-mechanical polishing, so that, upon completion of the planarization step E3, the thin layer 10 presents a thickness e10 which is substantially equal to a target thickness, said thickness e10 being even and extending up to the peripheral edge b10. By “thickness substantially equal to a target thickness”, it should be understood that, upon completion of the planarization step E3, the surface s10 of the thin layer 10 has a thickness evenness % StdD lower than 1% and/or a percentage of unevenness % NonU lower than 1%. For example, such a planarization step E3 may be implemented using a polishing solution based on particles, like silica (SiO₂) or alumina (Al₂O₃) particles; in a basic solution (ammonia solution, potassium carbonate, etc.). Polishing may be carried out with a pressure comprised between 1 psi and 7 psi, where 1 psi is substantially equal to 6,894.76 Pa; and with rotational speeds of the polishing head and of the plate comprised between RPM and 150 RPM, where 1 RPM is one revolution per minute.

In the case where the method for correcting thicknesses comprises a test sub-step E12, the planarization step E3 may be implemented in the same manner as the thinning implemented during the test sub-step E12. In other words, the polishing parameters and solutions used during the test sub-step E12 may be used during the planarization step E3 and vice versa.

Finally, the method for correcting thicknesses may advantageously comprise a heat treatment step E4, implemented after the etching step E2, in which the thin layer 10 undergoes a heat treatment at an annealing temperature comprised between 200° C. and 500° C. Thus, it is possible to remove, at least partially, any amorphous material layer formed at the surface s10 of the thin layer 10 during the etching step E2.

All of the previously-described arrangements allow providing a method for correcting thicknesses that takes advantage of the localized etching during the etching step E2 to create a specific topography of the thin layer 10. Thus, the etching step E2 allows preparing the surface s10 of the thin layer 10 to improve the thickness homogeneity obtained during the planarization step E3. In a synergistic manner, the planarization step E3 also allows removing any amorphous layer accidentally deposited during the etching step E2.

1. A method for correcting thicknesses comprising successively:
a step of providing carrier substrate comprising a main face and a secondary face opposite to the main face, the carrier substrate comprising a thin layer arranged on the side of the main face, the thin layer having a surface extending up to a peripheral edge;
an etching step, in which the thin layer is etched in a localized manner by localized ion bombing and only on the side of the surface of the thin layer, so that a thickness of the thin layer varies progressively from a center of the thin layer towards the peripheral edge according to a thickness profile, and so that, upon completion of the etching step, the thickness profile of the etched thin layer has a concave or convex shape; and
a planarization step, in which the thin layer is thinned by chemical-mechanical polishing, so that, upon completion of the planarization step, the thickness of the thin layer is substantially constant.

2. The method for correcting thicknesses according to claim 1, comprising a test sub-step, implemented before the etching step, in which a test substrate comprising a test thin layer is provided, the test thin layer being made of a material identical to a material of the thin layer, the test sub-step comprising:
thinning the test thin layer by chemical-mechanical polishing; then
measuring at different locations a thickness of the test thin layer, by ellipsometry or reflectometry, so as to determine, for each of the locations, a variation in the thickness of the test thin layer;
the etching step being implemented afterwards while taking account of the test sub-step.

3. The method for correcting thicknesses according to claim 2, wherein the planarization step is implemented in the same manner as the thinning implemented during the test sub-step.

4. The method for correcting thicknesses according to claim 1, wherein, during the provision step, the thin layer has a thickness smaller than 2 μm.

5. The method for correcting thicknesses according to claim 1, further comprising a heat treatment step, implemented after the etching step, in which the thin layer undergoes a heat treatment at an annealing temperature comprised between 200° C. and 500° C.

6. The method for correcting thicknesses according to claim 1, wherein the thin layer is a layer of a pyroelectric, ferroelectric or piezoelectric material.

7. The method for correcting thicknesses according to claim 6, wherein the thin layer comprises LiNbO₃ or LiTaO₃.

8. The method for correcting thicknesses according to claim 1, further comprising a measuring step, implemented before the etching step, in which a measurement at different locations of a thickness of the thin layer is carried out by ellipsometry or reflectometry.

9. The method for correcting thicknesses according to claim 1, wherein the provision step comprises the following steps:
a step of providing a donor substrate comprising a thick layer, the donor substrate having a bonding surface on the side of the thick layer;
an implantation step, in which light species are implanted in the thick layer to generate an embrittlement plane therein and thus define the thin layer between the embrittlement plane and the bonding surface of the donor substrate;
an assembly step, in which the bonding surface of the donor substrate is brought into contact with a receiving face of the carrier substrate substrate;
a detachment step, in which the thin layer is formed by detachment of a portion of the thick layer at the embrittlement plane, by application of a heat treatment.

10. The method for correcting thicknesses according to claim 1, wherein, during the etching step, a variation in the thickness of the thin layer between the center of the thin layer and the peripheral edge is comprised between 50 nm and 200 nm.
